(19) United States
(12) Patent Application Publication
(10) Pub. No.: US 2026/0068898 A1
(43) Pub. Date: Mar. 12, 2026

(54) DRY AND SHELF-STABLE FERMENTED MILK PRODUCT

(71) Applicant: Advanced Bionutrition Corp., Columbia, MD (US)

(72) Inventors: Mordechai Harel, Pikesville, MD (US); Majid Keshtmand, Baltimore, MD (US); Huyen Nguyen, Lanham, MD (US); Brian Carpenter, Baltimore, MD (US)

(73) Assignee: Advanced Bionutrition Corp., Columbia, MD (US)

(21) Appl. No.: 19/389,546

(22) Filed: Nov. 14, 2025

Related U.S. Application Data
(62) Division of application No. 18/569,404.

(51) Int. Cl. A23C 9/123; A23C 11/10; A23L 33/17

(52) U.S. Cl. CPC A23C 9/1232; A23C 11/10; A23L 33/17

(57) ABSTRACT

A fermented milk composition is provided. The composition comprises fermented milk, proteins, and optionally, sugars, oligosaccharides and carboxylic acid salts. The fermented milk comprises viable microorganisms. The composition has a neutral to slightly alkaline pH. Also provided are a method of preparing a dry fermented milk composition and a method of determining stability of the dry fermented milk composition.

### CROSS-REFERENCE TO RELATED APPLICATION

This application is a divisional application of application Ser. No. 18/569,404, filed Dec. 12, 2023, which is a U.S. National Phase application of International Application No. PCT/US21/042977, filed Jul. 23, 2021, the contents of each of which are incorporated herein by reference in their entireties.

### FIELD OF THE INVENTION

The present invention relates to a stable fermented milk product such as a dry shelf-stable yogurt or kefir product in a form of, for example, free flowing powder, granules, beads, chewable bites or pressed tablets, and preparation and uses thereof.

### BACKGROUND OF THE INVENTION

Dairy milk has been used to produce fermented milk products as far back as 10,000 B.C. in different regions all over the world. The processes used to turn milk into different fermented foods involve adding lactic-acid-producing microorganisms, such as bacteria and yeast, which ingest lactose, or milk sugar, and release lactic acid. The accumulation of the lactic acid in the milk result in a rise in milk acidity, which allows the production of kefir, yogurt, cheese and sour cream among other fermented foods. The many benefits of fermented milk products include enhanced digestibility, new and unique flavors, added probiotics, essential vitamins and minerals, and preservation products for a food that typically has a very short shelf life.

Yogurt is one type of fermented milk that is a staple in the Middle Eastern diet for thousands of years. Yogurt is a fermented food that holds the same level of protein and fat as the milk from which it is produced. It is also a source of calcium and vitamins B2, B6 and B12. Yogurt, like other fermented milk products, is primarily cultured from cow's milk, but can be made from goat's milk and even non-dairy milks, including coconut milk, almond milk, and soy milk.

Kefir is another popular type of fermented milk. It is a cultured milk beverage made by adding kefir starter grains to various milk products (i.e., cow, goat, soy, and other commonly consumed milks). The word “kefir” is derived from the Turkish word “keif,” which means “good feeling”. The broad community of probiotic microorganisms in the kefir grains that contain active microorganisms, comprised of 83 to 90 percent lactic acid bacteria and 10 to 17 percent yeast, ferment the milk to create the cultured product. Kefir also incorporates various essential vitamins such as B2, B12, D, K and A; minerals, particularly phosphorus, magnesium, calcium; amino acids; short peptides; and enzymes. Kefir grains are not consumed as part of the final product but are removed with a strainer at the completion of fermentation and added to a new batch of unfermented milk. Kefir grains will also ferment milk substitutes such as soy milk, rice milk, and coconut milk, as well as other sugary liquids including fruit juice and coconut water. However, the kefir grains may cease growing if the medium used does not contain all the growth factors required by the bacteria. Kefir beads are kept viable as a mother or starter culture by transferring them daily into fresh milk and allowing them to ferment the milk for approximately 10-20 hours, during which time the beads will have increased in mass by about 25%.

The resulting kefir milk fermentation has a uniform creamy consistency and a slightly acidic taste (pH may vary between 4 and 5) caused mostly by the metabolic degradation of lactose to lactic acid. It may have some effervescence due to carbon dioxide production, a minute (0.08-2%) concentration of alcohol due to the action of yeast cells in the mother culture beads, and also contains a variety of aromatic substances which give it a characteristic flavor.

Cheese may be the most popular fermented milk product, using more than one-third of all milk produced in the United States each year for its production. Both soft and hard cheeses are produced by culturing milk for an extended period of time. Certain types of cheeses can be made simply by removing the moisture from sour cream or yogurt. Some other types of cheese, however, require additional steps in the culturing and fermentation process. Over 2,000 varieties of cheese exist, with some of the most notable being cheddar, feta, cream, goat and blue cheeses.

Sour cream is yet another type of fermented milk. The original process for making sour cream was to simply let cream sour on its own. A more proactive process is achieved by adding the lactic-acid-producing bacteria Streptococcus lactis to the cream. The flavor of sour cream is mild and tangy, and the texture is thick and smooth with a fat content somewhere between 10 to 14 percent. Sour cream is added in many food product applications including cookies, cakes, breads, and pies.

In a typical milk fermentation process, a symbiotic relationship between the microorganisms is developed, wherein the bacteria and yeast survive and share their bioproducts as energy and nutrition sources and microbial growth factors. The microorganisms in the fermented milk are called probiotic because they are beneficial to human health. The probiotic microbial species are classified into four groups of microorganisms: homofermentative and heterofermentative lactic acid bacteria and lactose and non-lactose assimilating yeast. In a typical fermented milk, there are lactobacilli, such as Lb. brevis, Lb. cellobiosus, Lb. acidophilus, Lb. casei, Lb. helveticus, Lb. delbrueckii, Lb. lactis, etc.; lactococci, such as different subspecies of Lc. lactis, Streptococcus salivarius ssp. thermophilus, Leuconostoc mesenteroides and L. cremoris and a variety of yeasts, such as Kluyveromyces, Candida, Torulopsis, and Saccharomyces sp.

Fermented milk has been traditionally used for the alleviation and treatment of numerous conditions including metabolic disorders, atherosclerosis, allergic diseases, peptic ulcers, biliary tract diseases, chronic enteritis, bronchitis, and pneumonia. It has also been used to treat tuberculosis, cancer, and gastrointestinal disorders when medical treatment was unavailable. Controlled clinical trials have yet to confirm the utility of most of the above clinical uses and currently there are no regulations in the U.S. on the sale of fermented milk, yogurt, kefir, or kefir extract as natural health products.

There are many refrigerated fermented milk beverage products currently on the market. Refrigeration is the process of cooling or freezing the food product to lower temperatures, so as to extend the life of the food product. However, food products that require refrigeration can be maintained without spoiling only for short periods of time such as weeks or a few months. Refrigerated products are also more costly to distribute and store than non-refrigerated foods due to the energy costs associated with refrigeration or freezing. Therefore, there is a need for a shelf-stable fermented dairy product that is appealing to a consumer and does not need to be refrigerated.

An additional challenge to providing the consumer with dry non refrigerated shelf-stable fermented milk products is the preservation of the viability of live probiotic microorganisms in the products under the harsh conditions of typical industrial manufacturing processes and long-term storage at challenging temperature and humidity conditions. Although there have been some developments concerning stabilization techniques that protect the viability of live microorganisms during manufacturing, distribution and storage, there is still a critical need for stable live microorganism compositions suitable for distribution in geographic locations, including those in tropical climates, where the viability of probiotics can be compromised upon exposure to harsh environments, especially those associated with elevated temperature and humidity.

Hence, there is a long felt need for formulations containing live probiotic microorganisms that can be easily transported, taken regularly, have a reasonable shelf life, are easily digested, and do not contain excessive sweeteners and preservatives.

What are desired therefore are stable dry compositions, comprising fermented milk and other suitable ingredients, and stabilization techniques for making such compositions that preserve the viability of the microorganisms within the fermented milk without affecting its natural taste and structure.

### SUMMARY OF THE INVENTION

The present invention relates to stable fermented milk compositions and preparation thereof.

A composition is provided. The composition comprises fermented milk, and one or more proteins. The one or more proteins are selected from the group consisting of dairy proteins, plant proteins, and combinations thereof. The fermented milk comprises one or more viable microorganisms. The composition has a pH of 7-8.

The fermented milk may be selected from the group consisting of fermented cow milk, fermented goat milk, fermented soy milk, fermented rice milk, fermented coconut milk and combinations thereof. The fermented milk may be prepared from milk selected from the group consisting of fresh whole milk, reconstituted whole milk, non-fat dry milk and combinations thereof. The fermented milk may be selected from the group consisting of yogurt, kefir, cheese, sour cream, buttermilk and combinations thereof. The fermented milk may be kefir.

In one embodiment, the pH of the fermented milk is adjusted to neutral or slightly alkaline, for example, a pH of 7-8. The one or more proteins may be concentrated, isolated, partially hydrolyzed or hydrolyzed proteins. The one or more proteins may be selected from the group consisting of casein, whey protein, pea protein, soy protein and combinations thereof. The composition may comprise at least 5-35 wt % of the one or more proteins, based on the dry weight of the composition.

The composition may further comprise one or more sugars. The one or more sugars may be selected from the group consisting of glucose, fructose, sucrose, trehalose, lactose, maltose, isomaltose and combinations thereof. The composition may comprise at least 10-50 wt % of the one or more sugars, based on the dry weight of the composition. The composition may further comprise one or more oligosaccharides. The one or more oligosaccharides may be selected from the group consisting of inulin, short-chain oligosaccharides, cyclodextrins, maltodextrins, dextrans, fructo-oligosaccharides (FOS), galacto-oligosaccharides (GOS), mannan-oligosaccharides (MOS), and combinations thereof. The composition may comprise 5-35 wt % of the one or more oligosaccharides, based on the dry weight of the composition.

The composition may further comprise one or more carboxylic acid salts. The one or more carboxylic acid salts may be one or more salts of one or more carboxylic acids. The one or more carboxylic acid may be selected from the group consisting of lactic acid, ascorbic acid, maleic acid, oxalic acid, malonic acid, malic acid, succinic acid, citric acid, gluconic acid, glutamic acid, tartaric acid and combinations thereof. The composition may comprise 1-10 wt % of the one or more carboxylic acid salts, based on the dry weight of the composition. The composition may comprise fermented milk and one or more proteins, one or more sugars, one or more oligosaccharides and one or more carboxylic acid salts. The one or more proteins may be selected from the group consisting of dairy and plant proteins. The fermented milk may comprise one or more viable microorganisms. The composition may have a pH of 7-8. The one or more sugars may be selected from the group consisting of glucose, fructose, sucrose, trehalose, lactose, maltose, isomaltose and combinations thereof. The one or more oligosaccharides may be selected from the group consisting of inulin, short-chain oligosaccharides, cyclodextrins, maltodextrins, dextrans, fructo-oligosaccharides (FOS), galacto-oligosaccharides (GOS), mannan-oligosaccharides (MOS), and combinations thereof. The one or more carboxylic acid salts may be one or more salts of one or more carboxylic acids selected from the group consisting of lactic acid, ascorbic acid, maleic acid, oxalic acid, malonic acid, malic acid, succinic acid, citric acid, gluconic acid, glutamic acid, tartaric acid and combinations thereof.

The composition may further comprise a flavoring agent.

The viable microorganisms may comprise viable lactobacilli having an initial viability of at least 1×10⁸ colony forming units (CFU) over the dry weight of the composition (CFU/g), and the composition may lose less than 1 log CFU/g of the viable lactobacilli after being stored for at least 84 days at a temperature of 40° C. and a relative humidity of 33%.

A method for preparing a dry composition is provided. The method comprises (a) combining fermented milk with one or more proteins, and optionally with the one or more sugars, the one or more oligosaccharides and the one or more carboxylic acid salts, wherein the one or more proteins are selected from the group consisting of dairy and plant proteins, and the fermented milk comprises one or more viable microorganisms, whereby a slurry is formed; (b) adjusting the pH of the slurry to a pH of 7-8; (c) snap-freezing the slurry of step (b) in liquid nitrogen, whereby solid frozen particles in a form of beads, droplets or strings are formed; (d) primary drying the solid frozen particles by evaporation, under vacuum, while maintaining the temperature of the particles above their freezing temperature, whereby a primarily-dried formulation is formed; and (e) secondary drying the primarily-dried formulation under full strength vacuum with a heat source temperature of 20° C. or higher to reduce the water activity (Aw) of the primarily-dried formulation to 0.3 or lower, whereby the dry composition is prepared.

The preparation method may further comprise spray drying of the slurry.

The preparation method may further comprise compressing the dry composition, whereby beads or tablets are formed.

The preparation method may further comprise dissolving the one or more proteins and optionally, the one or more sugars, the one or more oligosaccharides and the one or more carboxylic acid salts in an alkali aqueous solvent before step (a), whereby an alkaline solution is formed. The preparation method may further comprise combining the alkaline solution with the fermented milk, whereby an alkaline slurry is formed in step (a) and adjusting the pH of the alkaline slurry to 7-8 in step (b). The preparation method may further comprise sterilizing or pasteurizing the alkali solution before step (a). For each preparation method of the present invention, a dry composition prepared according to the method is provided.

A method of making a dry product is provided. The method comprises mixing any of the dry compositions of the present invention with a carrier. The dry product may be selected from the group consisting of pharmaceutical products, nutraceutical products, food products, and special dietary products. The dry product may be in a form of powder, granules, beads, chewable bites or tablets.

A method of determining stability of the dry composition of the present invention is provided. The method comprises storing the dry composition for at least 14 days at a temperature greater than 15° C. and a relative humidity (RH) no greater than 60% and measuring a viability loss of the dry composition after storing step. A viability loss less than 1 log colony forming unit (CFU) of the viable microorganisms over the weight of the dry composition (CFU/g) indicates that the dry composition is stable.

### BRIEF DESCRIPTION OF THE DRAWINGS

FIG. 1 shows storage stability of a dry kefir cultured milk product prepared according to Examples 2 and packed in a sealed aluminum foil sachet. The sealed sachet was exposed to 25° C. and 60% RH or 30° C. and 65% RH for 28 days.

FIG. 2 shows storage stability of dry kefir cultured milk prepared according to Example 3 under accelerated storage conditions of 40° C. and 33% RH.

FIG. 3 shows storage stability of dry kefir cultured milk prepared according to Example 4 under accelerated storage conditions of 40° C. and 33% RH.

FIG. 4 shows storage stability of dry kefir cultured milk prepared according to Example 5 under accelerated storage conditions of 40° C. and 33% RH.

FIG. 5 shows storage stability of dry kefir cultured milk and 3 commercially available dry kefir starter products under accelerated storage conditions of 40° C. and 33% RH.

FIG. 6 shows storage stability of dry kefir cultured milk after press tableting under accelerated storage conditions of 40° C. and 33% RH.

### DETAILED DESCRIPTION OF THE INVENTION

The present invention provides novel fermented milk compositions and methods for drying and using such compositions. These compositions provide surprisingly better stability and protection of viable microorganisms in the fermented milk compositions. The viable microorganisms may be protected during manufacturing processes for making consumable products, through distribution channels, and under extreme storage conditions. For example, the shelf life of such stable dry fermented milk compositions stored under non-refrigerated conditions may be extended to 12 months or more.

Unless indicated otherwise, each percentage is a percentage by weight, and each weight percentage (wt %) of an ingredient in a composition is based on the dry weight of the composition (w/w).

A dry composition is a substance that is dehydrated or anhydrous, e.g., substantially lacking liquid. The dry substance, for example, a composition of the present invention, may be dried by evaporation by one or more drying processes, for example, air drying, vacuum drying, fluidized bed drying, or spray drying.

The term “water activity (Aw)” as used herein refers to the availability of water in a substance and represents the energy status of water in the substance. It may be defined as the vapor pressure of water above a substance divided by that of pure water at the same temperature. Pure distilled water has a water activity of exactly one, i.e., Aw=1.0. The dry composition may have an Aw of about 0.5 or lower, about 0.3 or lower, about 0.2 or lower, or about 0.1 or lower.

The term “fermented milk” or “cultured milk” are used herein interchangeably and refer to a fermented preparation produced by adding lactic-acid-producing microorganisms, such as bacteria and yeasts, into a milk that ingest lactose or other carbohydrates in the milk and release lactic acid. This results in a rise in milk acidity, which allows production of a fermented milk such as yogurt, kefir, cheese and sour cream.

Fermented milks such as kefir are defined in the Codex Alimentarius as a starter bacterial culture or starter culture prepared from kefir grains and typically include any species of the genera Leuconostoc, Lactococcus and Acetobacter growing in a strong specific relationship. Milk-fermenting probiotic microorganisms may be selected from the group consisting of Aerococcus, Aspergillus, Bacteroides, Bifidobacterium, Candida, Clostridium, Debaromyces, Enterococcus, Fusobacterium, Lactobacillus, Lactococcus, Leuconostoc, Melissococcus, Micrococcus, Mucor, Oenococcus, Pediococcus, Penicillium, Peptostrepococcus, Pichia, Propionibacterium, Pseudocatenulatum, Rhizopus, Saccharomyces, Staphylococcus, Streptococcus, Torulopsis, Weissella, or combinations thereof. Kefir grains constitute both lactose-fermenting yeasts (Kluyveromyces marxianus, Lactobacillus kefiri) and non-lactose-fermenting yeasts (Saccharomyces unisporus, Saccharomyces cerevisiae and Saccharomyces exiguus). A typical fermented milk contains 2.8% min. milk proteins (% w/w), less than 10% (% w/w) milk fat, 0.6% min. (w/w) lactic acid and non-stated amount of ethanol. The sum of specific microorganisms constituting the starter culture (CFU/g, in total) is at a min. 1×10⁷ and Yeasts (CFU/g) at a min. 1×10⁴ (Codex Standard for Fermented Milks CODEX STAN 243-2003)

The terms “protein” as used herein refers to protein concentrates, isolates or hydrolysates. The terms “isolate” and “concentrate” refer to a protein that all other non-protein components have been partially or almost completely removed. Protein concentrates typically contain 60-80% proteins on a dry weight basis. Protein isolates typically contain about 80-95% proteins on a dry weight basis.

Suitable proteins for the composition of the present invention include dairy proteins, plant proteins, and combinations thereof. For example, suitable proteins include egg proteins, gelatin, milk proteins, casein, caseinates (e.g., all forms including sodium, calcium, potassium caseinates), whey protein, alpha and beta lacto-globulin, soy protein, pea protein, rice protein, wheat protein, and other plant proteins. Preferably, the proteins are those recommended for non-allergenic dietary uses.

The terms “partially hydrolyzed protein” or “hydrolyzed protein” as used herein refers to proteins broken down by hydrolysis or digestion into shorter peptide fragments and/or amino acids. The hydrolysis or digestion may be carried out by a strong acid, a strong base, an enzyme, or a combination thereof. The hydrolyzed protein may be from a dairy or a plant. The hydrolyzed proteins may be milk proteins, plant proteins, or a mixture thereof. The hydrolyzed protein may be partially or extensively hydrolyzed. The hydrolyzed protein may be a mixture of polypeptides and amino acids. Examples of the hydrolyzed proteins include hydrolyzed casein, hydrolyzed whey protein, hydrolyzed pea protein, hydrolyzed soy protein, and combinations thereof. In one embodiment, the hydrolyzed protein comprises hydrolyzed casein or pea proteins.

The term “pH-adjusted and dry fermented milk composition” as used herein refers to a composition that its pH was adjusted to about neutral or slightly alkaline pH and then followed by the drying process.

The term “sugar” as used herein refers to a monosaccharide, a disaccharide or a combination thereof.

The term “monosaccharide” as used herein refers to a simplest form of a carbohydrate consisting of a single unit of sugar. Examples of suitable monosaccharides include glucose, fructose, and galactose.

The term “disaccharide” as used herein refers to a sugar having two monosaccharides linked together. The monosaccharides in a disaccharide may be the same or different. Examples of suitable disaccharides include sucrose, trehalose, lactose, maltose, and isomaltose.

The term “oligosaccharide” as used herein refers to a carbohydrate having a small number of sugar units, typically 3-60 monosaccharides linked together. An oligosaccharide containing less than 9 units of monosaccharides is also known as a short-chain oligosaccharide. The monosaccharides in the oligosaccharide chain may be the same or different. Oligosaccharides are soluble fibers often considered as prebiotics in nutritional applications. Advantageously, soluble fibers pass through the stomach undigested and become available for digestion by the gut microflora. The incorporation of soluble fibers may also help to protect viable microorganisms from digestive enzymes and high acidity of the stomach. Examples of suitable oligosaccharides include inulin, maltodextrins, cyclodextrins, dextrans, fructo-oligosaccharides (FOS), galacto-oligosaccharides (GOS), mannan-oligosaccharides (MOS) and combinations thereof.

The term “carboxylic acid salt” as used herein refers to a salt of a carboxylic acid, also known as an organic acid. This carboxylic acid salt may provide enhanced stability to the composition and an additional benefit to the viable microorganisms in the composition. For example, the carboxylic acid salt may provide a therapeutic or immunogenic effect to a host who receives the composition. Suitable carboxylic acids may be selected from the group consisting of lactic acid, ascorbic acid, maleic acid, oxalic acid, malonic acid, malic acid, succinic acid, citric acid, gluconic acid, glutamic acid tartaric acid and a combination thereof.

Suitable salts may include cations such as sodium, potassium, calcium, magnesium, and a combination thereof. Examples of suitable carboxylic acid salts include sodium citrate, sodium lactate, sodium maleate, sodium tartrate, magnesium gluconate and sodium ascorbate, preferably salts of tartaric acid, citric acid or ascorbic acid (e.g., sodium or potassium citrate, ascorbate, trisodium citrate dehydrate or potassium bitartrate).

The term “viable microorganism” or “viable microorganisms” as used herein refers to a fermented milk containing one or more live microorganisms. The viable microorganism may provide or confer a biological benefit, including an immunogenic response, to a host when administered to the host in an effective amount. The desirable biological benefit may be any beneficial health, prophylactic, or nutritional effect, for example, maintaining healthy gastrointestinal flora, enhancing growth, enhancing reproduction, enhancing immunity, preventing diseases, allergies and cold, or protecting against diarrhea, atopic dermatitis, or urinary infection.

A fermented milk composition is provided. The composition comprises fermented milk, one or more proteins. The fermented milk comprises one or more viable microorganisms. The fermented milk may be pH-adjusted.

In one embodiment, the pH of the composition is about neutral or slightly alkaline pH. The composition may have a pH of 6.5-8.5, 6.5-8.0, 6.5-7.5, 6.5-7.0, 7.0-8.5, 7.0-8.0, 7.0-7.5, 7.5-8.5, 7.5-8.0 or 7.5-8.0.

The composition may comprise at least about 1, 5, 10, 15, 20, 25, 30 or 40 wt %, nor more than about 5, 10, 15, 20, 25, 30, 40 or 50 wt %, or at about 1-50, 1-40, 1-30, 1-20, 1-10, 1-5, 5-50, 5-40, 5-35, 5-30, 5-20, 5-10, 10-50, 10-40, 10-30, 10-25, 10-20 or 10-15 wt % of the one or more proteins, based on the dry weight of the composition. In one embodiment, the composition comprises at least about 10 wt % of the one or more proteins, based on the dry weight of the composition. In another embodiment, the composition comprises about 5-35 wt % of the one or more proteins, based on the dry weight of the composition. In yet another embodiment, the composition comprises about 5-30 wt % of the one or more proteins. The one or more proteins may be protein concentrates, isolates, hydrolysates or a mixture thereof.

The composition may further comprise one or more sugars. The one or more sugars may be selected from the group consisting of glucose, fructose, sucrose, trehalose, lactose, maltose, isomaltose and combinations thereof. The composition may comprise the one or more sugars at least about 1, 5, 10, 15, 20, 25, 30 or 40 wt %, no more than about 5, 10, 15, 20, 25, 30, 40 or 50 wt %, or at about 1-50, 1-40, 1-30, 1-20, 1-10, 1-5, 5-50, 5-40, 5-35, 5-30, 5-20, 5-10, 10-50, 10-40, 10-30, 10-25, 10-20 or 10-15 wt %, based on the dry weight of the composition. In one embodiment, the composition comprises at least about 20 wt % of the one or more sugars, based on the dry weight of the composition. In another embodiment, the composition comprises about 10-50 wt % of the one or more sugars, based on the dry weight of the composition. In yet another embodiment, the composition comprises about 10-40 wt % of the one or more sugars, based on the dry weight of the composition.

The composition may further comprise one or more oligosaccharides. The one or more oligosaccharides may be selected from the group consisting of inulin, short-chain oligosaccharides, cyclodextrins, maltodextrins, dextrans, fructo-oligosaccharides (FOS), galacto-oligosaccharides (GOS), mannan-oligosaccharides (MOS), and combinations thereof. The composition may comprise the one or more oligosaccharides at least about 1, 5, 10, 15, 20, 25, 30 or 40 wt %, nor more than about 5, 10, 15, 20, 25, 30, 40 or 50 wt %, or at about 1-50, 1-40, 1-30, 1-20, 1-10, 1-5, 5-50, 5-40, 5-35, 5-30, 5-20, 5-10, 10-50, 10-40, 10-30, 10-25, 10-20 or 10-15 wt %, based on the dry weight of the composition. In one embodiment, the composition may comprise at least about 10 wt % of the one or more oligosaccharides. In another embodiment, the composition may comprise about 5-35 wt % of one or more oligosaccharides. In yet another embodiment, the composition may comprise about 5-30 wt % of one or more oligosaccharides.

The composition may further comprise one or more carboxylic acid salts. The one or more carboxylic acid salts may be one or more salts of one or more carboxylic acids. The one or more carboxylic acids may be selected from the group consisting of lactic acid, ascorbic acid, maleic acid, oxalic acid, malonic acid, malic acid, succinic acid, citric acid, gluconic acid, glutamic acid, tartaric acid and combinations thereof. The composition may comprise the one or more carboxylic acid salts at least about 0.1, 0.5, 1, 5, 10, 15, 20 or 25 wt %, nor more than about 0.5, 1, 5, 10, 15, 20, 25 or 30 wt %, or about 0.1-20, 0.5-20, 1-20, 0.1-10, 0.5-10, 1-5, 1-10, 1-20, 1-30, 5-10, 5-20, 5-30, 10-15, 10-20, 10-25, or 10-30 wt %, based on the dry weight of the composition. In one embodiment, the composition may comprise about 1-10 wt % of one or more carboxylic acid salts.

The composition may further comprise about 10-40 wt % of the one or more sugars, about 5-30 wt % of the one or more oligosaccharides, about 1-10 wt % of the one or more carboxylic acid salts, or any combination thereof, based on the dry weight of the composition.

The composition may further comprise at least about 20 wt % the one or more sugars, at least about 10 wt % of the one or more oligosaccharides, at least about 2 wt % of the one or more carboxylic acid salts, or any combination thereof, based on the dry weight of the composition.

The composition may comprise fermented milk and one or more proteins, one or more sugars, one or more oligosaccharides and one or more carboxylic acid salts. The one or more proteins may be selected from the group consisting of dairy and plant proteins. The fermented milk may comprise one or more viable microorganisms. The composition may have a pH of 7-8. The one or more sugars may be selected from the group consisting of glucose, fructose, sucrose, trehalose, lactose, maltose, isomaltose and combinations thereof. The one or more oligosaccharides may be selected from the group consisting of inulin, short-chain oligosaccharides, cyclodextrins, maltodextrins, dextrans, fructo-oligosaccharides (FOS), galacto-oligosaccharides (GOS), mannan-oligosaccharides (MOS), and combinations thereof. The one or more carboxylic acid salts may be one or more salts of one or more carboxylic acids selected from the group consisting of lactic acid, ascorbic acid, maleic acid, oxalic acid, malonic acid, malic acid, succinic acid, citric acid, gluconic acid, glutamic acid, tartaric acid and combinations thereof.

In one embodiment, the composition comprises about 1-20 wt % of the one or more proteins, about 10-40 wt % of the one or more sugars, about 5-30 wt % of the one or more oligosaccharides, and about 1-10 wt % of the one or more carboxylic acid salts, based on the dry weight of the composition.

In another embodiment, the composition comprises at least about 10 wt % of the one or more proteins, at least about 20 wt % the one or more sugars, at least about 10 wt % of the one or more oligosaccharides, and at least about 2 wt % of the one or more carboxylic acid salts, based on the dry weight of the composition. In yet another embodiment, the composition comprises about 5-35 wt % of whey protein isolate, and optionally, about 5-35 wt % of inulin, about 10-50 wt % of trehalose or sucrose and about 0.1-10 wt % of one or more carboxylic acid salts, based on the dry weight of the composition. In yet another embodiment, the composition comprises about 5-30 wt % of whey protein isolate, and optionally, about 5-30 wt % of inulin, about 10-40 wt % of trehalose or sucrose and about 0.1-10 wt % of one or more carboxylic acid salts, which are selected from the group consisting of sodium or potassium citrate, sodium or potassium bitartrate monohydrate or sodium or potassium ascorbate, and combinations thereof, based on the dry weight of the composition.

The composition of the present invention may comprise an effective amount of one or more viable microorganisms for providing a biological, or probiotic, benefit to a host in a pharmaceutical product, a nutraceutical supplement product, and a dietary product, for example, a special dietary product such as an infant formula, a follow-on formula, processed cereal-based food, canned baby food, or special food for a medical purpose. The composition may further comprise one or more additional flavoring agents. For example, the composition may further comprise 0.1-10 wt % of a flavoring agent based on the dry weight of the composition. For example, additional flavoring agents may include natural flavors like fruits, vegetables, nuts, seafoods, vanilla, cocoa, spice blends and wines, or artificial flavors that imitate natural flavors. Some examples of artificial flavoring agents are esters that provide fruity flavors, ketones, pyrazines that provide a caramel flavor, and terpenoids that have citrus or pine flavor.

The U.S. Code of Federal Regulations defines natural flavorings as “the essential oil, oleoresin, essence or extractive, protein hydrolysate, distillate, or any product of roasting, heating or enzymolysis, which contains the flavoring constituents derived from a spice, fruit or fruit juice, vegetable or vegetable juice, edible yeast, herb, bark, bud, root, leaf or any other edible portions of a plant, meat, seafood, poultry, eggs, dairy products, or fermentation products thereof, whose primary function in food is flavoring rather than nutritional.”

Artificial flavoring agents are chemically similar to natural flavorings but are more easily available and less expensive. However, one drawback is that they may not be an exact copy of the natural flavorings they are imitating, such as amyl acetate which is used as banana flavoring or ethyl butyrate for pineapple flavoring.

The terms “viability” and “potency” are used herein interchangeably and refer to the ability of microorganisms in a composition to form colonies on a nutrient medium appropriate for the growth of the microorganisms and may be expressed as colony forming units (CFU) over the weight of the composition (CFU/g).

The potency of the composition of the present invention may be determined after serial dilutions and plating of the microorganisms on, for example, Lactobacilli MRS agar plates.

The composition may have an initial viability of at least about 1×10⁹, 1×10⁸, 1×10⁷ or 1×10⁶ CFU/g. For example, the composition may have an initial viability of at least about 1×10⁷ CFU/g. The composition may have a predetermined viability loss under predetermined storage conditions after a predetermined period of time.

The predetermined storage conditions may include a predetermined temperature and a predetermined relative humidity (RH). The term “relative humidity (RH)” as used herein refers to the amount of water vapor in the air, often at a given temperature. Relative humidity is usually less than that required to saturate the air and is often expressed in percentage of saturation humidity. The predetermined temperature may be at least about 0, 4, 5, 10, 15, 20, 25, 30, 35, 37, 40, 45 or 50° C., no more than about 4, 5, 10, 15, 20, 25, 30, 35, 37, 40, 45, 50 or 55° C., or in a range of about 5-55, 5-50, 5-40, 5-37, 5-35, 5-30, 5-25, 5-20, 5-15, 5-10, 10-55, 10-50, 10-40, 10-37, 10-35, 10-30, 10-25, 10-20, 10-15, 5-10, 15-55, 15-50, 15-40, 15-37, 15-35, 15-30, 15-25, 15-20, 20-55, 20-50, 20-40, 20-37, 20-35, 20-30, 20-25, 25-55, 25-50, 25-40, 25-37, 25-35 or 25-30° C. The predetermined relative humidity (RH) may be at least about 10, 20, 30, 33, 35, 40, 50, 60, 70 or 80%, no more than 10, 20, 30, 33, 35, 40, 50, 60, 70 or 80%, or in a range of about 10-80, 20-70, or 30-60%. The predetermined conditions may be accelerated storage conditions. For example, the predetermined conditions may include about 40° C. and about 33% RH, or about 45° C. and about 33% RH.

The predetermined period of time may be at least about 1, 2, 3 or 4 weeks, or 1, 2, 3, 4, 5, 6, 12, 18, 24 or 36 months, preferably at least about 1, 2 or 3 months, more preferably at least about 1 or 3 months. A specified time period may include a shorter or longer time period that is within 10% of the specified time period. The term “3 months” as used herein refers to a time period of about 84-90 days. The term “2 months” as used herein refers to a time period of about 56-60 days. The term “1 month” as used herein refers to a time period of about 28-30 days.

As used herein, the term “shelf-stable” means a composition comprising viable microorganisms capable of being stored at room temperature (e.g., about 20-25° C.) for a long period (e.g., more than 3 months) while losing less than about 1 log CFU/g of the viable microorganisms.

In one embodiment, the dry shelf-stable fermented milk composition has a viability loss of less than about 1 log (CFU/g) under predetermined conditions and after a predetermined period of time. For example, the composition may have a viability loss of less than about 1 log (CFU/g) after about 1, 2 or 3 months at about 40° C. and 33% RH.

In one embodiment, the composition has an initial viability of at least 1×10⁸ CFU/g, and it loses less than about 1 log (CFU/g) after 3 months (e.g., 84 days) at 40° C. and 33% RH. In one embodiment, the fermented milk is a yogurt, buttermilk, sour cream, or kefir fermentation harvest that is concentrated to a wet paste-like consistency and having a solid content of about 5-30% w/v. The concentrate can be in a form of wet, frozen, or thawed paste before being combined with the stabilizing ingredients.

The preparation of the composition may include aseptically mixing fermented milk or a concentrate of fermented milk, adding stabilizing ingredients according to composition of the present invention under slight agitation at a predetermined temperature and time period to form a fermented milk slurry, adjusting the pH of the slurry with concentrated NaOH to a neutral or slightly alkaline pH, snap-freezing the slurry in liquid nitrogen to form particles in the form of droplets, strings or beads. The composition may be dried by evaporating the moisture in the particles under a regimen of reduced pressure while supplying heat to the particles. The resulting stable dry composition may be packaged or combined with other ingredients to form a product such as a pharmaceutical product, a nutraceutical supplement product, or a dietary product. In particular, the resulting dry composition may be added with a desirable flavoring agent and press tableted to form tasty and chewable tablets. The composition of the present invention may also be prepared by techniques known in the art. The preparation method may include processes such aseptic microbial culturing, centrifuging, mixing, freezing, freeze-drying, ambient air-drying, vacuum drying, spray drying, vacuum spray drying or a combination thereof.

One suitable process may include mixing an active starter culture or kefir grains with fresh or reconstituted milk, fermenting the milk under slight agitation at 20-27° C. for about 10-22 hours or until the pH is dropped to about 4.3-4.8, straining the kefir grains from the cultured milk, and optionally, concentrating the cultured milk. The process may include adding a dry mixture of all ingredients in the composition directly into a milk culture or a concentrated milk culture comprising the live microorganism to form a slurry. Alternatively, the dry ingredients mixture may be pre-dissolved in a water solution, adjusted to a pH of 8-9 with a concentrated alkali solution (e.g., 1M or 5M sodium hydroxide (NaOH) solution) and pasteurized at 75-90° C. for 15-30 minutes prior to adding to the milk culture. In the fermented milk composition slurry, the dry weight mass of the cultured milk may constitute about 5-30% w/v while the dry ingredients mixture may constitute about 10-60% or 20-50% w/v. The total solids content in the slurry may be about 25-90% or 30-60%. The final pH of the composition slurry is about neutral or slightly alkaline pH, for example, pH of 7-8.

The composition slurry may be frozen to about −30° C. or to about −80° C., or snap-frozen in liquid nitrogen by atomizing, dripping, or injecting into a liquid nitrogen bath. The resulting particles in the form of beads, strings or droplets may be collected and dried in a freeze drier or vacuum drier, or alternatively stored in a deep freezer (e.g., between −30° C. and −80° C.) for later drying, e.g., by vacuum drying or spray drying.

The frozen slurry particles may be loaded onto trays at a loading capacity from about 0.1 kg/sq.ft. to about 2 kg/sq. ft and then immediately transferred to a vacuum drying chamber where the drying process may proceed in three major steps including: (a) an optional short acclimation and structure stabilizing step of the frozen particles under a vacuum pressure of less than <1000 mTorr, (b) primary drying, or primary evaporative drying, under vacuum and at a temperature of the particles above their freezing point, and (c) secondary drying under full strength vacuum pressure and at an elevated heat source temperature for a time sufficient to reduce the water activity of the resulting dry composition to, for example, about 0.3 Aw or less. The resulting dry composition may be glassy amorphous.

The terms “lyophilization” and “freeze drying” are used herein interchangeably and refer to the preparation of a material in a dry form by rapid freezing and dehydration in a frozen state (also referred to as sublimation). Lyophilization takes place at a temperature that is below the freezing temperature of the composition, which may result in the crystallization of ingredients in the composition.

The term “primary drying” as used herein refers to a drying step in which the temperature of a material is maintained substantially lower than the temperature of a heat source, i.e., radiant or conductive heat source temperature, to make a primarily-dried material. Typically, during the primary drying step, the bulk of the moisture is removed from the material by extensive evaporation, while the material temperature is maintained above its freezing temperature but significantly lower than the temperature of the heat source. The term “secondary drying” as used herein refers to a drying step in which the temperature of the primarily-dried material is maintained near the temperature of a heat source, i.e., radiant or conductive heat source temperature, to make a dry material. This process may take place under vacuum sufficient to reduce the water activity of the resulting dry material. In a typical drying process, a secondary drying step reduces the water activity of the material to, for example, an Aw of about 0.3 or less.

For each dry composition of the present invention, a method of preparing such a dry composition is provided. The method comprises (a) forming a slurry by combining the fermented milk, the proteins, and optionally, the sugars, the oligosaccharides, and the carboxylic acid salts and adjusting the pH of the slurry to a neutral or slightly alkaline pH; (b) forming solid frozen particles in a form of beads, droplets or strings by snap-freezing the slurry in liquid nitrogen; (c) forming a primarily-dried composition by primary drying the solid frozen particles by evaporation, under vacuum, while maintaining the temperature of the particles above their freezing temperature; and (d) reducing the water activity (Aw) of the primarily-dried composition to be about 0.3 or lower by secondary drying the primarily-dried composition at full vacuum (<100 mTorr) and a heat source temperature of 20° C. or higher.

The composition of the invention may optionally comprise adding less than 10 wt % of one or more desirable flavoring agents to step (a), based on the dry weight of the composition. The method of the invention may optionally comprise concentrating the fermented milk and combining the concentrated fermented milk with the dry or pre-solubilized ingredients to form the slurry of step (a). The concentration of the fermented milk may be achieved by any method known in the art, for example, precipitation, centrifugation, filtration under pressure or vacuum, etc.

The method may further comprise sterilizing or pasteurizing the stabilizing ingredients before introducing in step (a). The sterilization or pasteurization may be achieved by any method known in the art, for example, heating under pressure or under vacuum an aqueous mixture of the proteins, and optionally, the oligosaccharides, the sugars, and the carboxylic acid salts, followed by cooling before adding in step (a).

The method may further comprise dissolving the stabilizing ingredients in an alkali solution followed by sterilizing or pasteurizing before adding in step (a).

The method may further comprise cutting, crushing, milling, or pulverizing the dry composition into a free-flowing powder. The particle size of the powder may be less than about 10,000, 1,000, 500, 250 or 100 μm, preferably less than about 5,000 μm. The milled composition may also be pressed into tablets by any known method in the art.

Other optional ingredients can be added to make the dry fermented milk products sufficiently palatable. For example, the dry fermented milk products of the present invention can optionally include conventional food additives, such as any of acidulants, additional thickeners, buffers or agents for pH adjustment, chelating agents, colorants, emulsifiers, excipients, flavor agents, minerals, osmotic agents, pharmaceutically acceptable carriers, preservatives, stabilizers, sugars, sweeteners, texturizers, or combinations thereof. The optional ingredients can be added in any suitable amount.

The composition of the present invention may be used directly as a flake, bead, granule, chewable tablet, or grounded into a powder and sieved to an average particle size of about 1-10,000 μm, preferably 100-5,000 μm.

The composition of the present invention may be consumed as a dry powder, granules, beads, chewable bites or pressed tablets sprinkled on food or salads, or reconstituted in liquid (e.g., a beverage) or mixed with milk and cultured overnight. It may also be incorporated either in flake, granule, bead, or powder form into an existing food product. The method may further comprise making a pharmaceutical product, a nutraceutical supplement product, or a dietary product with the composition of the present invention, which comprises an effective amount of the dry and shelf-stable fermented milk for providing a probiotic benefit to a host in the product. Examples of a special dietary product may include an infant formula, a follow-on formula and toddler formula, food products for elderly people, processed cereal-based food, and special foods for a medical purpose. A method of making a dry product is provided. The method comprises combining the dry fermented milk composition of the present invention with a carrier. The dry product may be selected from the group consisting of pharmaceutical products, nutraceutical products, food products, and special dietary products. The dry product may be in a form of powder, granules, beads, chewable bites or tablets, breakfast cereals, energy bars and alike. A method of measuring the stability of the dry composition of the present invention is provided. The dry composition comprises fermented milk, which comprises viable microorganisms. The method comprises storing the dry composition for a predetermined period of time under predetermined storage conditions such that the dry composition has a predetermined viability loss. The initial viability may be at least about 1×10⁹, 1×10⁸, 1×10⁷ or 1×10⁶ CFU/g. For example, the dry composition may have an initial viability of at least about 1×10⁷ CFU/g. The predetermined viability loss may be less than 0.1, 0.5, 1.0, 1.5 or 2.0 log CFU/g.

According to the stability measurement method, the predetermined storage conditions may include a predetermined temperature and a predetermined relative humidity (RH). The predetermined temperature may be at least about 0, 4, 5, 10, 15, 20, 25, 30, 35, 37, 40, 45 or 50° C., no more than about 4, 5, 10, 15, 20, 25, 30, 35, 37, 40, 45, 50 or 55° C., or in a range of about 5-55, 5-50, 5-40, 5-37, 5-35, 5-30, 5-25, 5-20, 5-15, 5-10, 10-55, 10-50, 10-40, 10-37, 10-35, 10-30, 10-25, 10-20, 10-15, 5-10, 15-55, 15-50, 15-40, 15-37, 15-35, 15-30, 15-25, 15-20, 20-55, 20-50, 20-40, 20-37, 20-35, 20-30, 20-25, 25-55, 25-50, 25-40, 25-37, 25-35 or 25-30° C. The predetermined relative humidity (RH) may be at least about 10, 20, 30, 33, 35, 40, 50, 60, 70 or 80%, no more than 10, 20, 30, 33, 35, 40, 50, 60, 70 or 80%, or in a range of about 10-80, 20-70, or 30-60%. The predetermined conditions may be accelerated storage conditions. For example, the predetermined conditions may include about 40° C. and about 33% RH, or about 45° C. and about 33% RH. According to the stability measurement method, the predetermined period of time may be at least about 1, 2, 3 or 4 weeks, or 1, 2, 3, 4, 5, 6, 12, 18, 24 or 36 months, preferably at least about 1, 2 or 3 months, more preferably at least about 1 or 3 months. A specified time period may include a shorter or longer time period that is within 10% of the specified time period. The term “3 months” as used herein refers to a time period of about 84-90 days. The term “2 months” as used herein refers to a time period of about 56-60 days. The term “1 month” as used herein refers to a time period of about 28-30 days.

In one embodiment, the method of measuring the stability of the dry composition of the present invention comprises storing the dry composition for at least 14 days at a temperature greater than 15° C. and a relative humidity (RH) no greater than 60%, whereby the dry composition loses less than 1 log colony forming unit (CFU) of the viable microorganisms over the weight of the dry composition (CFU/g).

### Example 1. Stability of Freeze-Dried Kefir Fermented Milk Comprising a Sugar

The stability of a freeze-dried kefir cultured milk with added sugar was evaluated. Grade A homogenized and pasteurized whole milk was purchased from a local grocery. 1200 ml of the fresh milk was placed in a 4 L sterilized glass reactor vessel. Kefir grains were obtained from a commercially available source. The grains were kept activated in fresh milk (the milk was refreshed on a daily basis). Twelve (12) grams of active kefir grains were mixed into the milk in the reactor vessel, and the vessel was placed in an enclosed and temperature-controlled shaker. The culture conditions were set at a temperature of 28° C.±0.5 under slow agitation at 90-100 rpm. The milk was cultured until the pH of the cultured milk reached 4.3±0.1 (for 15-22 hrs.). The kefir grains were strained from the cultured milk with a sieve.

Two hundred and forty (240) grams of trehalose (Cargill, Minneapolis, MN) was added to the kefir cultured milk under continuous mixing at 700 rpm in an agitated 4 L glass reactor vessel. The mixed slurry was then dripped into and snap-frozen in a liquid nitrogen bath to form frozen beads, which were harvested from the liquid nitrogen and stored at −80° C. for later drying.

For drying, the frozen beads were spread on pre-cooled trays (−20° C.) at a loading capacity of 1000 g/sq.ft. and then immediately placed on shelves in a freeze drier (Model 25 SRC, Virtis, Gardiner, NY). The freeze drying was initiated under full vacuum pressure (i.e., 50-200 mTorr) and the shelf temperature set at 20° C. These drying temperature and vacuum pressure settings were maintained for 72 hours. As a result, the kefir cultured milk was completely dried and its water activity as measured by a Hygropalm Aw1 instrument (Rotonic Instrument Corp., Huntington, NY) was below Aw 0.3. The dry material was then passed through a grinding mill and sieved to particle size≤3000 μm and stored at 4° C. For shelf-storage stability evaluation, the freeze-dried kefir cultured milk containing trehalose was mixed with an equal amount of maltodextrin (1:1 ratio) and placed in an open tube in a desiccator under 40° C. and 33% RH storage conditions. Samples were taken periodically for total Lactobacilli CFU assessment using standard microbiological dilutions and LMRS agar plating procedures.

Stability results under 40° C. and 33% RH storage conditions:

The freeze-dried kefir cultured milk with the added sugar lost over three (3) logs total Lactobacilli CFU/g within 14 days when exposed to the storage conditions of 40° C. and 33% RH. These results demonstrate that adding sugars to fermented milk and drying by standard lyophilization in a freeze drier do not provide shelf-stable” composition (e.g., losing less than about one log CFU/g of the viable microorganisms after 3 months) for the live microorganisms under non-refrigerated storage conditions.

### Example 2. Stability of Kefir Fermented Milk Comprising a Sugar and an Oligosaccharide and Dried by Evaporation, Under Vacuum, According to the Drying Method of the Present Invention

The stability of a dry kefir cultured milk with added sugar and oligosaccharide and dried by evaporation, under vacuum was evaluated. Grade A homogenized and pasteurized whole milk was purchased from a local grocery. A quantity of 1200 ml of the fresh milk was placed in a 4 L sterilized glass reactor vessel. Kefir grains were obtained from a commercially available source. The grains were kept activated in fresh milk (the milk was refreshed on a daily basis). Twelve (12) grams of active kefir grains were mixed into the milk in the reactor vessel, and the vessel was placed in an enclosed and temperature-controlled shaker. The culture conditions were set at a temperature of 28° C.±0.5 under slow agitation at 90-100 rpm. The milk was cultured until the pH of the cultured milk reached 4.3±0.1 (for 15-22 hrs.). The kefir grains were strained from the cultured milk with a sieve. Two hundred and forty (240) grams of a dry mixture containing trehalose (Cargill, Minneapolis, MN) and inulin (instant inulin, Cargill, Minneapolis, MN), at a ratio of 1:1 w/w was added to the kefir cultured milk under continuous mixing at 700 rpm in an agitated 4 L glass reactor vessel. The mixed slurry was then dripped into and snap-frozen in a liquid nitrogen bath to form frozen beads, which were harvested from the liquid nitrogen and stored at −80° C. for later drying. For drying by evaporation, under vacuum, the frozen beads were spread on pre-cooled trays (−20° C.) at a loading capacity of 1000 g/sq.ft. and then immediately placed on shelves in a freeze drier (Model 25 SRC, Virtis, Gardiner, NY). The primary drying step was initiated by adjusting the vacuum to 1000 mTorr and the shelf temperature raised to 30° C. These primary drying temperature and vacuum pressure settings were maintained for 12 hours. Before initiating primary drying, the temperature of the frozen beads was optionally acclimated to about −20° C. by applying a vacuum pressure at about 1000 mTorr with no heat to allow the temperature of the frozen beads to stabilize at about −20° C. for about 10 minutes. The optional acclimation step was then followed by a primary drying step at a vacuum pressure of 1000 mTorr and the shelf temperature of +20° C. for about 12 hours. After the primary drying step, a secondary drying step followed at full strength vacuum (i.e., 50-200 mTorr) and the shelf temperature was raised to 40° C. for an additional 12 hours. As a result, the kefir cultured milk was completely dried and its water activity as measured by a Hygropalm Aw1 instrument (Rotonic Instrument Corp., Huntington, NY), was below Aw 0.3. The dry material was then passed through a grinding mill and sieved to particle size≤3000 μm and stored at 4° C.

The dry kefir cultured milk containing trehalose and inulin was mixed with an equal amount of maltodextrin (1:1 ratio) and placed in a desiccator under accelerated storage conditions. Samples were taken periodically for total Lactobacilli CFU assessment using standard microbiological dilutions and LMRS agar plating procedures.

### Quality Control Checks of the Fermented Milk:

| Test | Specifications | Measuring Time |
|---|---|---|
| Fermentate pH | 4.3 ± | After 15 hrs. incubation |
| | 0.2 | and every hour thereafter |
| | | until pH reaches 4.3 ± 0.2 |
| Fermentate Temperature | 28° C. ± | Monitor during incubation |
| | 0.5 | period |
| Fermentate % Total Acidity | ≥0.6% | After pH reaches the spec. |
| Fermentate-total | ≥1.0 + E08 | After pH reaches the spec. |
| lactobacilli plate counts | CFU/g | |
| % Solids of Liquid Mixed | 30% ± | After slurry mixing |
| Slurry | 3 | |
| Viscosity of Liquid Mixed | ≤3000 | After slurry mixing |
| Slurry | cp | |
| Dry Fermented Milk Aw | ≤0.2 | After drying completed |
| Dry Fermented Milk total | ≥1 × 10⁹ | After drying completed |
| Lactobacilli plate counts | CFU/g | |

### Dried Fermented Milk Proximate Composition (% Dry Weight)

| | |
|---|---|
| Milk Proteins | 2.5% |
| Milk Fats | 9% |
| Total Carbohydrates | 88.5% |
| Dietary fibers | 33.3% |
| Sugars | 55.3% |
| Total Lactobacilli CFU | 5 billion/g |

### Stability Results Under Non-Refrigerated Storage Conditions:

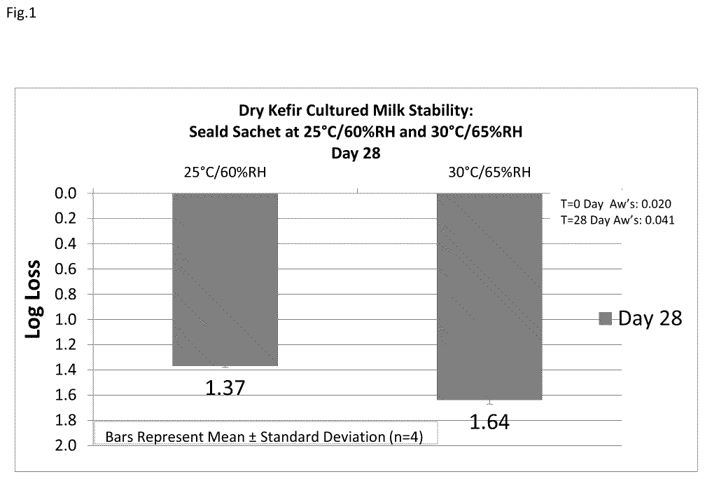

FIG. 1 shows the storage stability results when the dry Kefir cultured milk of Example 1 was sealed in aluminum foil sachet and the sachet exposed to 25° C. and 60% RH or 30° C. and 65% RH. The potency of the dry cultured milk, in terms of total Lactobacilli CFU/g, was reduced by over a log after 28 days exposure non-refrigerated storage conditions. These results demonstrate that adding both sugars and oligosaccharides to fermented milk and drying by evaporation, under vacuum, according to the drying method of the present invention, did not provide “shelf-stable” composition (losing less than about one log CFU/g after 3 months) for the live microorganisms under non-refrigerated storage conditions.

### Example 3. Stability of Dry Kefir Fermented Milk Comprising a Sugar, an Oligosaccharide and a Carboxylic Acid Salt and Dried by Evaporation, Under Vacuum According to the Drying Method of the Present Invention

The stability of a dry kefir fermented milk with an added sugar, oligosaccharide and carboxylic acid was evaluated.

A dry fermented milk was prepared as described in Example 2, except that the dry mixture contained 120 g of trehalose, 60 g of inulin, 6 g of sodium ascorbate (Sigma-Aldrich, Inc., St. Louis, MO) and 12 g sodium citrate (Sigma-Aldrich, Inc., St. Louis, MO). The dry mixture was added to the kefir fermented milk under continuous mixing. The fermented milk was processed and dried by evaporation as described in Example 2.

For shelf storage stability evaluation, the dry fermented milk containing trehalose, inulin, sodium ascorbate and sodium citrate was mixed with an equal amount of maltodextrin (1:1 ratio) and placed in a desiccator under accelerated storage conditions. Samples were taken periodically for total Lactobacilli CFU assessment using standard microbiological dilutions and LMRS agar plating procedures.

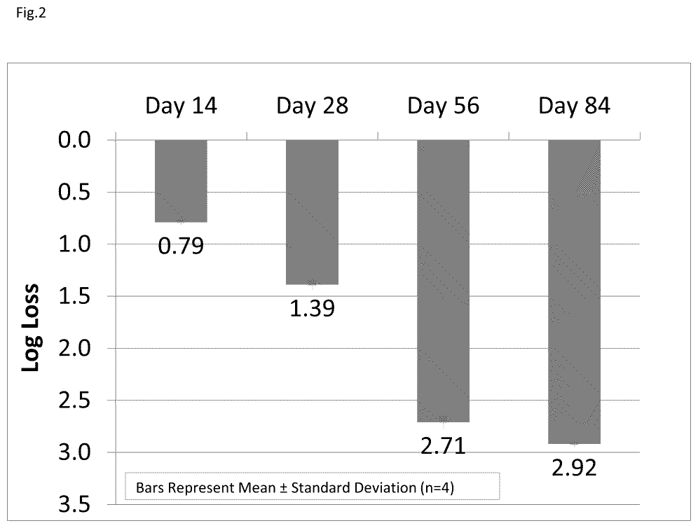

FIG. 2 shows the storage stability results under non-refrigerated storage conditions of 40° C. and 33% RH. The dry fermented milk of Example 3 lost almost 3 logs CFU/g after 84 days exposure to 40° C. and 33% RH. These results demonstrate that adding sugars, oligosaccharides and carboxylic acids to fermented milk did not provide “shelf-stable” composition (losing less than about one log CFU/g after 3 months) for the dry live microorganisms under the above testing conditions.

### Example 4. Stability of Dry Kefir Fermented Milk Comprising a Sugar, an Oligosaccharide and a Carboxylic Acid Salt with pH Adjustment

The effect of pH on the stability of a dry kefir fermented milk with an added sugar, oligosaccharide and carboxylic acid was evaluated.

A dry fermented milk was prepared as described in Example 2 except that a dry mixture containing 120 g trehalose, 60 g inulin and 18 g sodium ascorbate was dissolved in 80 g water, and the pH of the solution was adjusted to 8.5 using a 20% concentrated NaOH solution. The pH-adjusted solution was added to the kefir fermented milk under continuous mixing. The pH of the final fermented milk slurry was about 7-8. The fermented milk was then processed and dried by evaporation, under vacuum, as described in Example 2. For shelf storage stability evaluation, the dried pH-adjusted fermented milk containing trehalose, inulin and sodium ascorbate was mixed with an equal amount of maltodextrin (1:1 ratio) and placed in a desiccator under accelerated storage conditions. Samples were taken periodically for total Lactobacilli CFU assessment using standard microbiological dilutions and LMRS agar plating procedures.

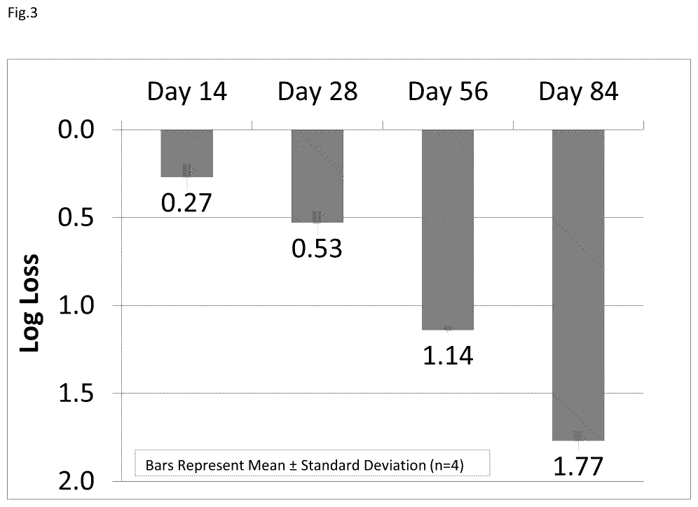

FIG. 3 shows the storage stability results under accelerated storage conditions of 40° C. and 33% RH. The dry fermented milk of Example 4 lost less than 2 logs CFU/g after 84 days exposure to 40° C. and 33% RH. These results demonstrate that adjusting the pH of the fermented milk slurry to neutral or slightly alkaline pH and then drying by evaporation, under vacuum, according to the drying method of the present invention, significantly improved the stability of the dry fermented milk, as compared with the sample stability of a of Example 3.

### Example 5. Stability of Dry Kefir Fermented Milk Comprising a Protein, a Sugar, an Oligosaccharide and a Carboxylic Acid Salt

The stability of a dry kefir fermented milk with an added protein, sugar, oligosaccharide and carboxylic acid was evaluated.

A dry fermented milk was prepared as described in Example 2 except that the dry mixture contained 60 g beta lactoglobulin (Davisco Foods Int. Inc., Le Sueur, MN), 120 g trehalose, 60 g inulin, 6 g sodium ascorbate and 18 g sodium citrate. The dry mixture was dissolved in 80 g water and added to the kefir fermented milk under continuous mixing. The fermented milk was processed and dried as described in Example 2.

For shelf storage stability evaluation, the dry fermented milk containing the beta lactoglobulin, trehalose, inulin, sodium citrate and sodium ascorbate was mixed with an equal amount of maltodextrin (1:1 ratio) and placed in a desiccator under accelerated storage conditions. Samples were taken periodically for total Lactobacilli CFU assessment using standard microbiological dilutions and LMRS agar plating procedures.

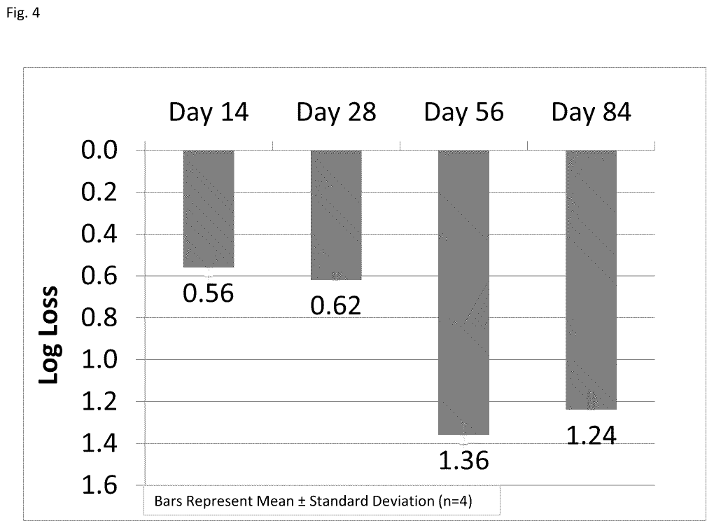

FIG. 4 shows the storage stability results under accelerated storage conditions of 40° C. and 33% RH. The dry fermented milk of Example 5 lost only 1.24 logs CFU/g after 84 days exposure to 40° C. and 33% RH. These results demonstrate that the composition of the present invention as described in Example 5 provides significant protection to the live microorganisms of the dry fermented milk composition, and provided an acceptable “shelf-stable” composition (losing less than about one log CFU/g after 3 months) for the dry live microorganisms under the above non refrigerated storage conditions.

### Example 6. Stability of Dry Kefir Fermented Milk Comprising a Protein, a Sugar, an Oligosaccharide and a Carboxylic Acid Salt with pH Adjustment

The stability of a dry kefir fermented milk with an added protein, sugar, oligosaccharide, and carboxylic acid (Example 5) and with pH adjustment as described in Example 4 will be evaluated.

A dry fermented milk will be prepared as described in Example 5. A dry mixture containing 60 g whey protein isolate (Bipro, Davisco Foods Int. Inc., Le Sueur, MN), 120 g trehalose, 60 g inulin, 6 g sodium ascorbate and 18 g sodium citrate will be dissolved in 80 g water and the pH of the solution will be adjusted to 8.5 using a 20% concentrated NaOH solution. The pH adjusted solution will be added to the fermented milk under continuous mixing. The pH-adjusted fermented milk composition will be then processed and dried by evaporation, under vacuum, as described in Example 2.

The pH-adjusted, to neutral or slightly alkaline pH, dry fermented milk containing whey protein isolate, trehalose, inulin, sodium citrate and sodium ascorbate will be mixed with an equal amount of maltodextrin (1:1 ratio) and placed in a desiccator under accelerated storage conditions of 40° C. and 33% RH. Samples will be taken periodically for total Lactobacilli CFU assessment using standard microbiological dilutions and LMRS agar plating procedures.

The dry shelf-stable fermented milk of the present invention will be a “shelf-stable” composition and lose less than about 1 log CFU/g of potency after 84 days under non refrigerated storage conditions.

### Example 7. Potency Effect of Replacement of the Fresh Whole Milk with Reconstituted Dry Milk Powder

The effect of milk source on the potency of the dry fermented milk was evaluated. A dry fermented milk was prepared as described in Example 3, except that the fresh whole milk was replaced with 10% w/w reconstituted dry whole milk (Hoosier Hill Farm LLC., Fort Wayne, IN) or 10% w/w reconstituted non-fat dry milk (obtained from a local grocery store). The fermented reconstituted milk was processed and dried by evaporation, under vacuum, as described in Example 2.

The total Lactobacilli CFU/g in the dry fermented milk was assessed using standard microbiological dilutions and LMRS agar plating procedures. Table 1 shows that replacing the whole fresh milk with reconstituted milk powder was resulted in higher fermented milk potency.

TABLE 1
Effect of the milk source on dry fermented milk potency

| Milk Source | Total Lactobacilli (CFU/g) |
|---|---|
| Fresh whole milk | 2.74 × 10⁹ CFU/g |
| Dry whole milk powder | 4.60 × 10⁹ CFU/g |
| Non-fat dry milk powder | 5.56 × 10⁹ CFU/g |

### Example 8. Stability Comparison of the Dry Kefir Fermented Milk Composition According to the Present Invention with Three Commercially Available Dry Kefir Starter Culture Products

Dry kefir fermented milk was prepared as described in Example 5 except that the beta lactoglobulin was replaced with hydrolyzed pea protein (Friesland Campina DOMO, Paramus, NJ) in the dry mixture. The pH of the dry mixture solution was adjusted to 8.5 as described in Example 4. The pH-adjusted solution was added to the kefir culture milk under continuous mixing. The final pH of fermented milk slurry was about 7-8. The fermented milk slurry was then processed and dried by evaporation, under vacuum, as described in Example 2.

The dry fermented milk composition and three commercially available kefir starter culture products (Commercial A, Commercial B and Commercial C) were mixed with an equal amount of maltodextrin (1:1 ratio) and placed in a desiccator under accelerated storage conditions. Samples were taken periodically for total Lactobacilli CFU assessment using standard microbiological dilutions and LMRS agar plating procedures.

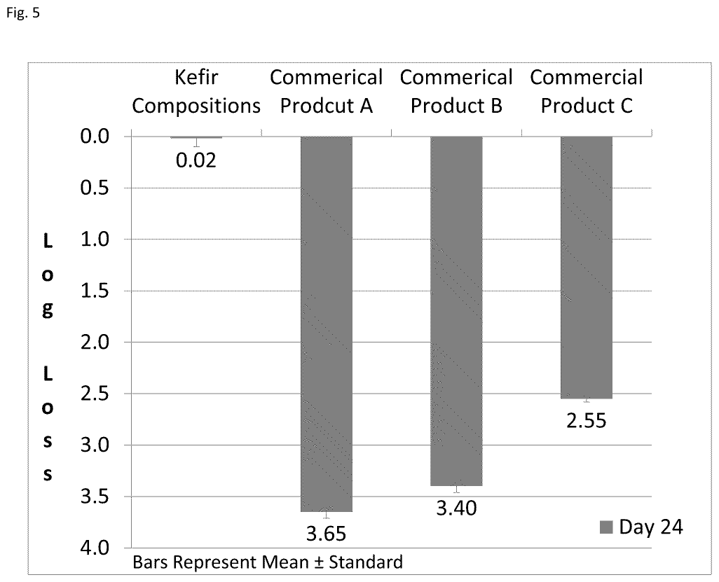

FIG. 5 shows the storage stability results under non refrigerated storage conditions of 40° C. and 33% RH. All three dry commercial kefir starter products lost a significant amount of viability (2.55-3.65 log CFU/g after 24 days), while the dry kefir fermented milk composition of the present invention had practically no viability loss under the above non refrigerated storage conditions.

### Example 9. Taste Liking Comparison of the Dry Kefir Fermented Milk Composition of the Present Invention with Three Commercially Available Dry Kefir Starter Culture Products

The dry kefir fermented milk and the three commercially available dry kefir starter culture products from Example 5 were subjected to taste-liking evaluation by a panel of randomly selected and non-professional group of 11 subjects. The panel evaluated the taste of the four samples when consumed as 1) a dry powder form and 2) after culturing overnight in a glass of milk following the instructions provided on the packaging of each commercial product. Table 2 shows that only the taste of the dry kefir composition of the present invention was liked by the panel. All of the four samples were successfully fermented in a glass of milk. Taste-liking results of the fermented milks varied across all the four samples while the kefir composition of the present invention and Commercial A product scored the most likeable taste.

TABLE 2
Summary of the taste liking scores by a panel of 11 subjects.

| | | Taste-liking score |
|---|---|---|
| | Taste-liking score | after overnight |
| | as dry powder | culture in milk |
| | (% of 11 subjects) | (% of 11 subjects) |
| Kefir fermented milk | 100% | 27% |
| of the present invention | | |
| Commercial A product | 0% | 45% |
| Commercial B product | 0% | 18% |
| Commercial C product | 0% | 10% |

### Example 10. Stable and Dry Kefir Fermented Milk in Chewable Tablets

Dry kefir fermented milk was prepared as described in Example 8. The fermented milk was processed and dried by evaporation, under vacuum, as described in Example 2. For tableting, the dry and shelf-stable composition (1600 mg) was mixed with 130 mg sucrose, 40 mg magnesium stearate (Sigma-Aldrich, Inc., St Louis, MO) and 20 mg hydrophilic fumed silica (AEROSIL® 200, Evonik Industries AG, Parsippany, NJ) and compressed into rounded 0.7874″ diameter tablets using a single-station bench top tablet press (Model NPRD10, Natoli, Saint Charles, MO). The tablets were exposed to a controlled temperature and humidity environment of 40° C. and 33% RH. Tablets were periodically removed for total Lactobacilli CFU assessment using standard microbiological dilutions and LMRS agar plating procedures.

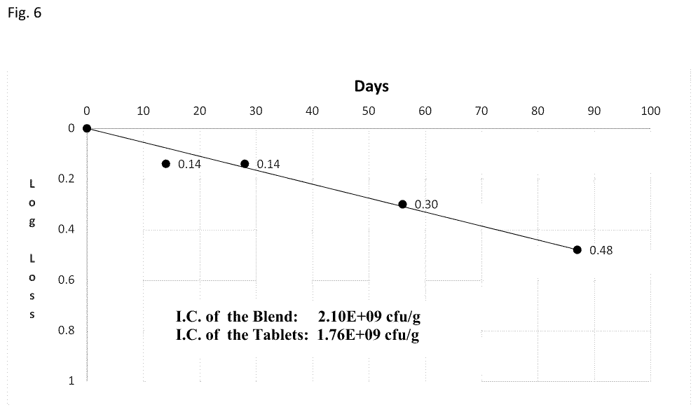

FIG. 6 shows the storage stability results under non refrigerated storage conditions of 40° C. and 33% RH. The dry shelf-stable fermented milk composition of the present invention lost only 14% of potency in the tableting process and 0.49 log CFU/g after 84 days under the above storage conditions. Those results demonstrated that the composition of the present invention was a “shelf-stable” composition (losing less than about one log CFU/g after 3 months) for the dry live microorganisms under the above non refrigerated storage conditions.

### Example 11. Consumption of the Dry Shelf-Stable Fermented Milk

Dry and shelf-stable fermented milk was prepared as described in Example 4. The fermented milk was processed and dried as described in Example 2. Five grams of the dry powder containing a daily dose of about 5 billion total Lactobacilli CFU was packaged in aluminum foil sachets. The preferred mode of consumption was evaluated by a panel of randomly selected 19 non-professional subjects. The subjects consumed the fermented milk dry powder either in powder form, mixed in a beverage, sprinkled on salads or foods or after overnight culture in a glass of milk. Table 3 shows the results of the preferred consumption as scored by the non-professional panel. The results in Table 3 show that most subjects preferred to consume the fermented milk dry powder in powder form, straight from the package or mixed in a beverage.

TABLE 3
Preferred consumption method options
of the dry fermented milk composition

| | Consumption Method Option Preferences |
|---|---|
| | (% of 19 subjects) |
| In powder form | 58% |
| Sprinkled on food | 32% |
| Mixed in beverage | 74% |
| Cultured in milk | 16% |

### Example 12. Dry and Shelf-Stable Fermented Milk Composition: Effect of Drying Methods on Potency and Shelf Storage Stability

A kefir fermented soymilk composition will be prepared as described in example 5. The fermented soy milk will be processed and dried as described in Example 2. Additionally, a portion of the liquid nitrogen frozen slurry will be lyophilized in a freeze drier under full vacuum and shelf temperature of +20° C. for 48 hours. Another sample will be prepared by spray drying the un-frozen slurry obtained as described in Example 5. The spray drying conditions will be set at 125° C. inlet and 65° C. outlet temperatures at about 5 ml feed rate. The initial total Lactobacilli CFU/g will be evaluated after drying by each of the three drying methods and also after subjecting the samples to a controlled environment of temperature and humidity of 40° C. and 33% RH for 3 months.

The term “about” as used herein when referring to a measurable value such as an amount, a percentage, and the like, is meant to encompass variations of ±20% or ±10%, more preferably ±5%, even more preferably ±1%, and still more preferably ±0.1% from the specified value, as such variations are appropriate.

All documents, books, manuals, papers, patents, published patent applications, guides, abstracts, and other references cited herein are incorporated by reference in their entirety.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

What is claimed is:

1. A method for preparing a dry composition, comprising:
(a) combining fermented milk with one or more proteins, and optionally one or more sugars, one or more oligosaccharides and one or more carboxylic acid salts, wherein the fermented milk comprises one or more viable microorganisms, whereby a slurry is formed;
(b) adjusting the pH of the slurry to a pH of 7-8;
(c) snap-freezing the slurry of step (b) in liquid nitrogen, whereby solid frozen particles are formed in the form of beads, droplets or strings;
(d) primary drying the solid frozen particles by evaporation, under vacuum, while maintaining the temperature of the particles above their freezing temperature, whereby a primarily-dried composition is formed; and
(e) secondary drying the primarily-dried composition under full strength vacuum with a heat source temperature of 20° C. or higher to reduce the water activity (Aw) of the primarily-dried composition to 0.3 or lower, whereby a dry composition is prepared.

2. The method of claim 1, further comprising spray drying of the slurry of step (b).

3. The method of claim 1, further comprising pressing the dry composition, whereby beads or tablets are formed.

4. The method of claim 1, further comprising dissolving the one or more proteins, and optionally the one or more sugars, the one of more oligosaccharides and the one or more carboxylic acid salts in an alkaline aqueous solvent before step (a), whereby an alkaline solution is formed.

5. The method of claim 4, further comprising combining the alkaline solution with the fermented milk, whereby an alkaline slurry is formed in step (a) and adjusting the pH of the alkaline slurry to 7-8 in step (b).

6. The method of claim 4, further comprising sterilizing or pasteurizing the alkaline solution before step (a).

7. A dry composition prepared according to the method of claim 1.

8. A method of making a dry product, comprising combing the dry composition of claim 7 with a carrier.

9. The method of claim 8, wherein the dry product is selected from the group consisting of pharmaceutical products, nutraceutical products, food products, and special dietary products.

10. The method of claim 8, wherein the dry product is in the form of dry powder, dry granules, beads, chewable bites or tablets.

11. A method of determining stability of the dry composition of claim 7, comprising:
(a) storing the dry composition for at least 14 days at a temperature greater than 15° C. and a relative humidity (RH) no greater than 60%, and
(b) measuring a viability loss of the dry composition after step (a), wherein a viability loss less than 1 log colony forming unit (CFU) of the viable microorganisms over the weight of the dry composition (CFU/g) indicates that the dry composition is stable.

12. A method of determining stability of a dry composition, wherein the composition comprises fermented milk and one or more proteins, wherein the one or more proteins are selected from the group consisting of dairy and plant proteins, the fermented milk comprises one or more viable microorganisms, and the composition has a pH of 7-8, the method comprising:
(a) storing the dry composition for at least 14 days at a temperature greater than 15° C. and a relative humidity (RH) no greater than 60%, and
(b) measuring a viability loss of the dry composition after step (a), wherein a viability loss less than 1 log colony forming unit (CFU) of the viable microorganisms over the weight of the dry composition (CFU/g) indicates that the dry composition is stable.
